(19) United States
(12) Patent Application Publication
(10) Pub. No.: US 2008/0182623 A1
(43) Pub. Date: Jul. 31, 2008

(54) MOBILE TERMINAL APPARATUS AND WIRELESS COMMUNICATION METHOD USING THE SAME

(75) Inventor: Jin-Soo YOUN, Ansan City (KR)

Correspondence Address: BIRCH STEWART KOLASCH & BIRCH, PO BOX 747, FALLS CHURCH, VA, 22040-0747, US

(73) Assignee: LG Electronics, Inc., Seoul (KR)

(21) Appl. No.: 11/963,310

(22) Filed: Dec. 21, 2007

(30) Foreign Application Priority Data
Jan. 29, 2007 (KR) 10-2007-0009040

(51) Int. Cl. H04Q 7/22

(52) U.S. Cl. 455/558

(57) ABSTRACT

The present invention relates to a mobile terminal apparatus and a wireless communication method using the same, wherein any one of communication modules is selected according to the type of a smart card so that wireless data communication can be used through the selected communication module. In the present invention, at least two or more communication modules are mounted on the mobile terminal apparatus such as a notebook system. The communication modules are modules for supporting wireless data communication through different communication methods. If a smart card that uses a certain communication method is connected to the mobile terminal apparatus, the control unit recognizes a card detection signal to determine a connection state of the smart card, and controls to supply power to read identification information from the smart card. Upon supply of the power, the control unit preferentially reads the identification information and determines the type of the smart card. Then, based on a result of the determination, the control unit selects one of the communication modules that provides the same communication method as the communication type of the smart card and enables wireless data communication using the selected communication module. Accordingly, the present invention has an advantage in that wireless data communication can be performed through a variety of methods in one mobile terminal apparatus.

### BACKGROUND

1. Field

The present invention relates to a wireless communication method of a mobile terminal apparatus, and more particularly, to a mobile terminal apparatus and a wireless communication method using the same, wherein various kinds of smart cards for use in a plurality of communication modules are processed by using one smart card reader.

2. Description of the Related Art

Wireless data communication is a service in which a user can use a variety of contents information regardless of time and place after connecting with an Internet providing server using a mobile multimedia player (PMP), personal data assistant (PDA), cellular phone or the like. In a state where a communication module to which a certain communication method is applied and a smart card having user authentication information therein are provided, the wireless data communication is provided through a variety of mobile terminal apparatuses, such as a PMP, PDA, cellular phone or the like, after user authentication is completed.

However, wireless data communication has not yet been used in a notebook system. That is, although a conventional notebook system can utilize wireless data communication in a wireless local area network (LAN) environment only within a specific area, this means that Internet services are provided in a LAN communication method and thus the notebook system cannot employ a method of using the Internet in a wireless manner through a wireless communication network, such as a code division multiple access (CDMA) network.

Accordingly, a communication module capable of using a certain communication method is mounted on the notebook system so that the notebook system can use the wireless data communication. That is, in order to allow the notebook system to use the wireless Internet through a wireless network, a communication module for providing data services in a wireless mobile environment in the same manner as are used in a PMP, PDA or cellular phone is provided, and a smart card for performing user authentication and pay per use of the services and the like.

The communication module selectively uses any one of WiBro, high speed downlink packet access (HSDPA), and evolution data only (EVDO) methods. At the same time, a smart card corresponding to the communication method should be provided. Accordingly, since user authentication, a global roaming function, and a variety of transaction services are provided through the smart card, the notebook system can use wireless Internet services.

However, the notebook system is still provided with only one communication module that uses a certain communication method, and a method of using the wireless Internet by employing a plurality of different communication modules has not yet been implemented. Therefore, since the notebook system performs wireless communication only through a communication module mounted thereon, the notebook system cannot use other communication methods when the communication module does not support a communication method provided in a specific area or when a user desires to use another communication method.

In addition, even though the notebook system is provided with a plurality of communication modules, an authentication process through a smart card is needed in using each of the communication modules. In this case, smart card interfaces should be provided as many as the number of the communication modules. However, in the current circumstances where products are miniaturized and light-weighted, if a plurality of smart card interfaces are installed, there is a problem in that the products are difficult to design and become bulky.

### SUMMARY

An object of the present invention is to provide a mobile terminal apparatus, wherein smart cards for use in a plurality of communication modules are processed by using one smart card reader.

Another object of the present invention is to provide a wireless communication method using a mobile terminal apparatus, wherein when a smart card is mounted on a mobile terminal apparatus provided with a plurality of wireless communication modules, the type of the smart card is determined and a corresponding wireless communication module is selected so that wireless data communication can be used.

A mobile terminal apparatus according to one aspect of the present invention for achieving the objects comprises a wireless communication unit provided with at least two communication modules capable of performing wireless data communication; a smart card interface unit for communicating with a smart card that contains user authentication information needed for the wireless data communication and identification information for use in selecting a communication module used for the wireless data communication; and a control unit for confirming whether the smart card is provided and selecting and controlling one of the communication modules corresponding to the identification information received by the smart card interface unit.

The control unit may control to selectively supply power to the communication module corresponding to the identification information.

If the smart card is detached after being provided, the control unit may control to cut off the power supplied to the wireless communication unit

Further, a mobile terminal apparatus according to another aspect of the present invention for achieving the objects comprises a wireless communication unit provided with at least two communication modules capable of performing wireless data communication; a smart card interface unit for communicating with a smart card that contains user authentication information needed for the wireless data communication and identification information for use in selecting a communication module used for the wireless data communication; and a control unit for confirming whether the smart card is provided and selecting and controlling one of the communication modules corresponding to the identification information received by the smart card interface unit, wherein the control unit controls to selectively supply power to the communication module corresponding to the identification information to enable the wireless data communication and to cut off the power supplied to the communication module if the smart card is detached.

The identification information may be first provided to the control unit when the smart card is recognized, and specific bits of the provided data may be assigned to express the identification information in any one of a bitmap, binary digit, and vendor ID.

The wireless communication unit may comprise a first communication module including a first interface unit for communicating with the control unit; and a second communication module including a second interface unit that communicates with the control unit and employs a communication method different from that of the first interface unit. The communication modules may use an identical type of interface unit.

After the smart card is mounted, the control unit may control to supply power to the smart card so as to read data stored in the smart card.

The control unit may request to input information needed for performing user authentication if any one of the communication modules is intended to be used. The control unit may compare the user authentication information stored in the smart card with the inputted user information, and control whether to supply power to the communication module, based on a result of the comparison.

If the smart card is provided, the control unit may determines, based on a card detection signal generated from the smart card, that the smart card is connected to the smart card interface unit.

A logical low signal may be generated as the card detection signal if the smart card is attached to the smart card interface unit, and a logical high signal may be maintained as the card detection signal if the smart card is not attached to the smart card interface unit.

The communication modules may comprise modules employing various communication methods, such as a WiBro module, a high speed downlink packet access module, and an EVDO module.

The smart card may be a USIM card.

A wireless communication method using a mobile terminal apparatus according to the present invention for achieving the objects comprises the steps of detecting a smart card; supplying power to the detected smart card; if the power is supplied, reading identification information from the smart card and determining the type of the smart card; and selecting, based on a result of the determination, a communication module corresponding to the smart card from at least two communication modules capable of performing wireless communication.

The method may further comprise the step of supplying power to the selected communication module. The identification information may be first read when the smart card is recognized.

The method may further comprise the step of requesting to input information for user authentication if wireless communication is intended to be performed using the selected communication module. Power may be supplied to or cut off from the selected communication module based on a result of the user authentication.

A wireless communication method using a mobile terminal apparatus according to a further aspect of the present invention comprises the steps of detecting a smart card attached to one smart card reader and supplying power to the smart card; first reading identification information from the smart card; preferentially determining a communication method employed in the smart card by referring to the identification information; selecting a communication module corresponding to the smart card from two or more communication modules based on a result of the determination; requesting to input information for user authentication if wireless communication is intended to be performed using the selected communication module; and determining whether to supply power to the selected communication module, based on a result of the user authentication, and performing the wireless communication.

A plurality of interface units respectively provided in the communication modules to support certain communication methods may perform communication through an identical type of interface.

The communication modules may be provided to perform wireless communication through different communication methods.

If a logical low signal is generated as a card detection signal from the smart card, it may be determined that the smart card is connected to a smart card interface unit. The identification information may be expressed in as any one of a bitmap, binary digit, and vendor ID.

If the smart card is detached, the power supplied to the communication module may be cut off.

According to the present invention constructed as above, when a smart card using a certain communication method is connected to a mobile terminal apparatus on which at least two communication modules of different communication types are mounted, the type of the smart card is determined and a communication module that provides a corresponding communication method is selected, so that wireless data communication can be performed.

### BRIEF DESCRIPTION OF THE DRAWINGS

The above and other objects, features and advantages of the present invention will become apparent from the following description of preferred embodiments given in conjunction with the accompanying drawings, in which:

FIGS. 1a to 1c are views showing a configuration of a mobile terminal apparatus proposed to process a plurality of smart cards according to a preferred embodiment of the present invention;

FIG. 2 is a flowchart illustrating a process of confirming the type of a smart card referring to identification information of the smart card according to an embodiment of the present invention;

FIG. 3 is a flowchart illustrating a process of selecting a communication module corresponding to the smart card of which the type is confirmed in FIG. 2 and performing wireless data communication;

FIG. 4 is a flowchart illustrating a process of attaching and detaching a smart card according to an embodiment of the present invention; and

FIG. 5 is a timing chart showing the state of an electrical signal that is changed with the operations of attaching a smart card and selecting a communication module according to an embodiment of the present invention.

### DETAILED DESCRIPTION

Hereinafter, a mobile terminal apparatus according to a preferred embodiment of the present invention and a wireless communication method using the same will be described in detail with reference to the accompanying drawings.

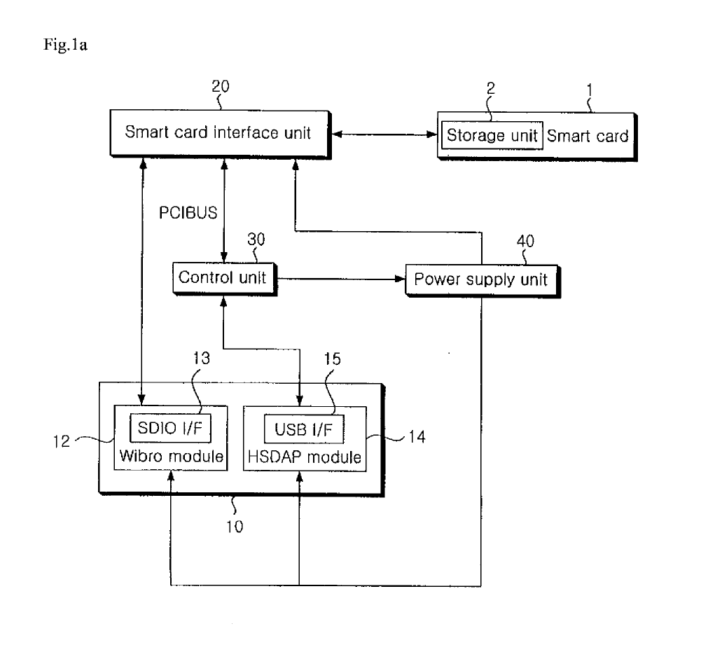

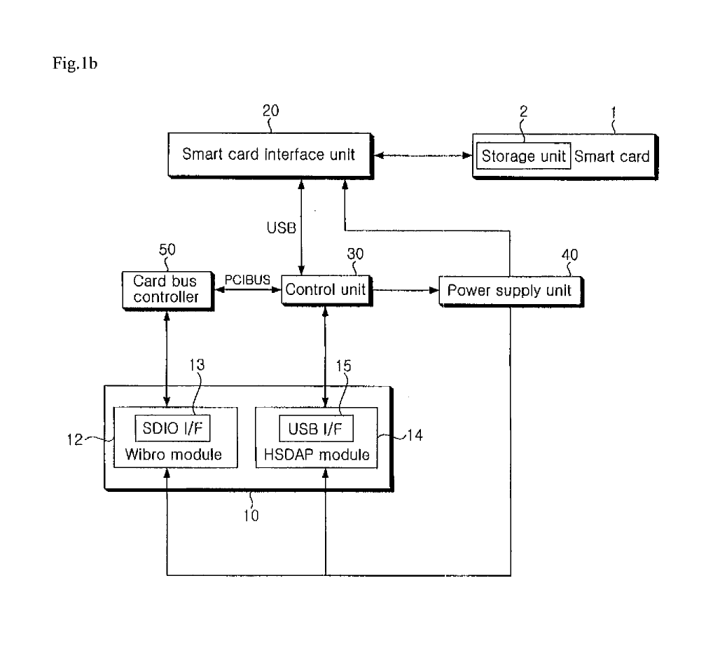

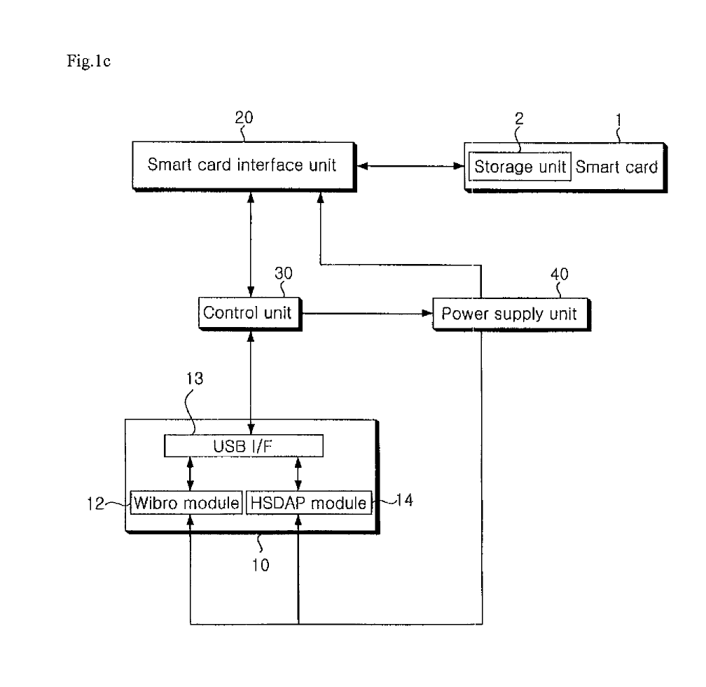

FIGS. 1a to 1c are views showing a configuration of a mobile terminal apparatus proposed to process a plurality of smart cards according to a preferred embodiment of the present invention.

In this embodiment, the mobile terminal apparatus will be described by way of example in connection with a notebook system.

FIG. 1a is a view showing a configuration of a mobile terminal apparatus that uses a card bus controller (e.g., TI Part: PCI7611) in which a smart card interface is supported. In this case, a smart card can be connected directly to an 8-pin socket type connector provided at a notebook system.

Referring to FIG. 1a, the mobile terminal apparatus comprises a wireless communication unit 10 for providing a wireless data communication function. The wireless communication unit 10 is provided with at least two communication modules, such as a first communication module 12 (hereinafter, referred to as a ‘WiBro module’) and a second communication module 14 (hereinafter, referred to as a ‘HSDPA module’).

Each of the WiBro module 12 and the HSDPA module 14 developed to be applied to a notebook system includes an interface for communicating with a control unit 30 which will be described below. In case of the WiBro module 12, a secure digital input/output (SDIO) interface 13 is used as the interface. In case of the HSDPA module 14, a universal serial bus (USB) interface 15 is used as the interface. The HSDPA module 14 is connected directly to the control unit 30, which will be described below, through the USB interface.

Next, when wireless data communication is used through the notebook system, the notebook system is provided with a smart card interface unit 20 for communicating with a smart card 1 that contains user authentication information and identification information for use in selecting a communication module used for the wireless data communication.

The smart card interface unit 20 receives a card detection signal of a certain logical signal from the smart card 1 and determines, based on the card detection signal, whether the smart card 1 is normally mounted. The card detection signal is generated from pin No. 8, i.e., a reserved pin that is not used, in a pin array of the smart card 1. In normal times, i.e., when the smart card 1 is not attached to the smart card interface unit 20, the card detection signal maintains a logical high state. When the smart card 1 is attached to the smart card interface unit 20, the state of the card detection signal is changed to a logical low state. That is, if the card detection signal is in a logical low state, it means that the smart card 1 has been attached to the smart card interface unit 20. In addition, the smart card interface unit 20 needs to read the identification information of the smart card 1 and to select either of the WiBro module 12 or the HSDPA module 14.

The smart card 1 stores the identification information, which contains information on a communication type used by the smart card itself, in a storage unit 2.

The identification information may be provided in various formats. The identification information is assigned with specific bits of packet data and thus can be expressed in the form of a bitmap, binary digit, vendor ID, or the like.

The identification information is data that are first read when the smart card 1 is recognized. When packet data stored in the smart card 1 are read, certain bits are assigned to a header of the packet data so that the type of the smart card 1 can be determined. For example, the bits can be expressed as shown in Tables 1 and 2 below.

TABLE 1

| 2 bits assigned out of 8-bit data | |
|---|---|
| stream | Communication type |
| 00 | WiBro type |
| 01 | High speed downlink packet access |
| | type |
| 10 | EVDO type |
| 11 | Other types |

In addition, the identification information contains the ID of a smart card vendor and the like, so that the type of the smart card can be determined from the vendor ID by referring to Table 2.

TABLE 2

| Vendor ID | Communication type |
|---|---|
| A | WiBro type |
| B | High speed downlink packet access type |
| C | EVDO type |
| D | Other types |

That is, it is possible to determine the type of a smart card for which each vendor uses a different communication type.

Next, the notebook system is provided with a control unit 30 for determining the type of the smart card 1 attached to the smart card interface unit 20 and selecting a module corresponding to the identification information to enable wireless communication.

When the smart card 1 is connected to the smart card interface unit 20, the control unit 30 receives a card detection signal, i.e., a logical low signal, generated from pin No. 8 of the smart card 1 and determines whether the smart card is connected. The control unit controls such that the power supply unit 40 supplies power to the smart card interface unit 20 so as to read the information stored in the smart card 1. Then, the control unit reads the identification information of the smart card 1 and determines the type of the smart card 1. Then, the control unit controls such that the power supply unit 40 supplies power to drive a module corresponding to the type of the smart card.

In addition, if the smart card 1 mounted on the smart card interface unit 20 is detached, the control unit 30 controls to cut off the power supplied to the currently selected module. Then, if a smart card 1 is newly connected, the control unit repetitively performs a series of the aforementioned operations of supplying power, determining the type of the smart card 1, and controlling the selected module.

In addition, if the control unit 30 desires to use a module selected from the WiBro module 12 and the HSDPA module 14 according to the type of the smart card 1, the control unit 30 controls to supply power to the selected module and the smart card 1 and requests to input information needed for user authentication as described above. At this time, if the user authentication is performed abnormally, the control unit controls to cut off the power supplied to the module.

Next, FIG. 1b is a view showing a configuration of a mobile terminal apparatus that uses a card bus controller (e.g., TI part: PCI7411) in which a smart card interface is not supported.

Since the configuration shown in FIG. 1b is similar to the configuration shown in FIG. 1a, descriptions of overlapping portions will be omitted. The only difference is that since a smart card cannot be connected directly to an 8-pin socket type connector as shown in FIG. 1a, a smart card reader should be used. Accordingly, in a state where a smart card is mounted on the smart card reader, the smart card reader is connected to the control unit of the notebook system through a USB interface. The smart card reader may be embedded in the notebook system or may be provided in the form of an external type smart card reader. In FIG. 1b, a description will be made by naming the smart card reader a smart card interface unit.

As shown in FIG. 1b, the smart card interface unit 20 is connected to the control unit 30 through a USB interface, and the HSDPA module 14 is also connected to the control unit 30 through a USB interface. However, since the WiBro module 12 uses the SDIO interface 13, it is connected to the control unit 30 through a card bus controller 50. At this time, the WiBro module 12 is connected to the card bus controller 50 through an SDIO interface method, and the card bus controller 50 is connected to the control unit 30 through a peripheral component interconnect (PCI) bus.

As described above, the communication modules 12 and 14 provided in the wireless communication unit 10 in FIGS. 1a and 1b use different interfaces.

However, if the WiBro module 12 uses a USB interface, it can be connected directly to the control unit 30, instead of being connected through the card bus controller 50.

That is, in FIG. 1c, since the WiBro module 12 is connected to the control unit 30 through the USB interface 13, all of the smart card interface unit 20, i.e., the smart card reader, the WiBro module 12, and the HSDPA module 14 are connected to the control unit 30 through the USB interface. Accordingly, from FIG. 1c, it is understood that the communication modules 12 and 14 provided in the wireless communication unit 10 use the same interface. At this time, although the USB interface 13 is configured to be used by both the WiBro module 12 and the HSDPA module 14, an independent USB interface may be configured for each of the modules.

Meanwhile, FIGS. 1a to 1c have been described in connection with the WiBro module 12 that is the first communication module, and the HSDPA module 14 that is the second communication module. However, it will be apparent that other than the WiBro module 12 and the HSDPA module 14, an EVDO module, a variety of communication modules capable of supporting the mobile Internet, and a newly standardized communication module may be additionally mounted. In addition, if the various communication modules described above are provided, each of the communication modules should be provided with an interface unit capable of supporting a certain communication method, such as a USB interface or an SDIO interface, in order to communicate with the control unit 30.

In addition, the interface unit may be designed integrally with or separately from the communication modules that are provided in the wireless communication unit 10.

Next, a method of performing wireless data communication using the mobile terminal apparatus configured as above according to the preferred embodiment of the present invention will be described with reference to the accompanying drawings.

In describing the embodiment of the present invention, the process of selecting a communication module corresponding to identification information of a smart card and performing wireless communication is equally applied to each of the mobile terminal apparatuses configured as shown in FIGS. 1a to 1c.

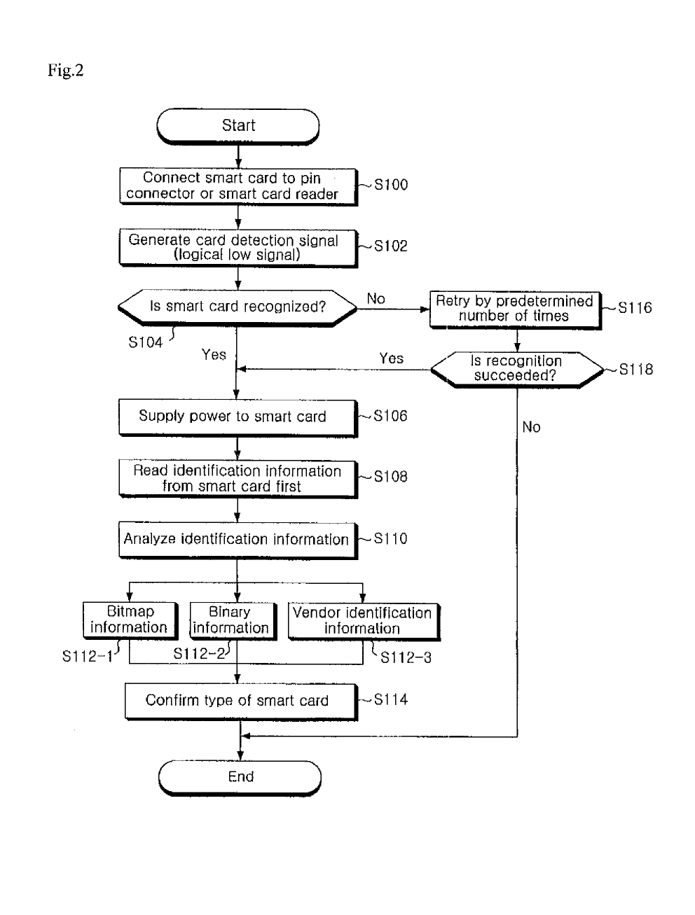

FIG. 2 is a flowchart illustrating a process of confirming the type of a smart card referring to identification information of the smart card according to an embodiment of the present invention.

First, the notebook system is provided with the WiBro module 12 and the HSDPA module 14. A user connects a smart card 1 corresponding to a desired communication module selected from the WiBro module 12 and the HSDPA module 14 (S100).

The smart card 1 is connected directly to an 8-pin socket type connector as shown in FIG. 1a, or connected to a smart card reader (i.e., the smart card interface unit 20) that is connected to the control unit 30 through a USB interface as shown in FIGS. 1b and 1c.

If the smart card 1 is connected to the smart card interface unit 20, a card detection signal is generated from an unused pin (pin No. 8) of the smart card 1 (S102). The card detection signal is in a logical high state in normal times, i.e., when the smart card 1 is not connected to the smart card interface unit 20. If the smart card 1 is connected to the smart card interface unit 20, the state is changed to a logical low state.

Accordingly, if the smart card 1 is connected to the smart card interface unit 20, a card detection signal of a logical low state is generated from pin No. 8 of the smart card 1, and the card detection signal is transferred to the control unit 30.

Then, the control unit 30 recognizes that the smart card 1 is connected to the smart card interface unit 20 (S104), and controls such that the power supply unit 40 supplies power to the smart card 1 to read identification information stored in the smart card 1 (S106). If the card detection signal of the smart card 1 is not changed, the control unit 30 controls such that the power supply unit 40 does not supply power to the smart card 1.

If the power is supplied, the control unit 30 accesses the smart card 1 and reads identification information stored in the storage unit 2 (S108). That is, the storage unit 2 stores packet data containing the identification information and the like. When the packet data are transmitted, the control unit 30 first reads the identification information stored in a header of the packet data. Then, the control unit analyzes the read identification information (S110).

The identification information is assigned with specific bits of the packet data and can be diversely expressed in the form of a bitmap (S112-1), binary digit (S112-2), vendor ID (S112-3), or the like.

For example, two bits are assigned to represent the type of the smart card 1 in Table 1. That is, the type of the smart card can be categorized into ‘00’: WiBro type, ‘01’: high speed downlink packet access type, ‘10’: EVDO type, and ‘11’: a new communication type. It will be apparent that if more communication modules are provided, three bits are assigned to categorize smart cards.

Moreover, the type of the smart card is categorized by the vender ID in Table 2.

In addition, it is possible to include various kinds of identification information, such as bitmap information, which is used for determining the type of the smart card 1, The control unit 30 determines a communication type, which is used by the smart card 1 mounted on the smart card interface unit 20, based on the analyzed identification information (S114).

For example, if the identification information is ‘00’ (in Table 1), the smart card 1 is confirmed to be a smart card that uses a WiBro method, and if the identification information is ‘B’ (in Table 2), the smart card 1 is confirmed to be a smart card that uses a HSDPA method.

Meanwhile, there may be as case where the smart card 1 is not normally recognized in step S104. For example, if a connection between the smart card interface unit 20 and the smart card 1 is unstable, or if the smart card 1 itself is defective, the control unit 30 retries the operation of recognizing the smart card 1 within a predetermined number of times (S 116), and controls to supply power to the smart card 1 or forcibly terminates the operation according to the result (8118).

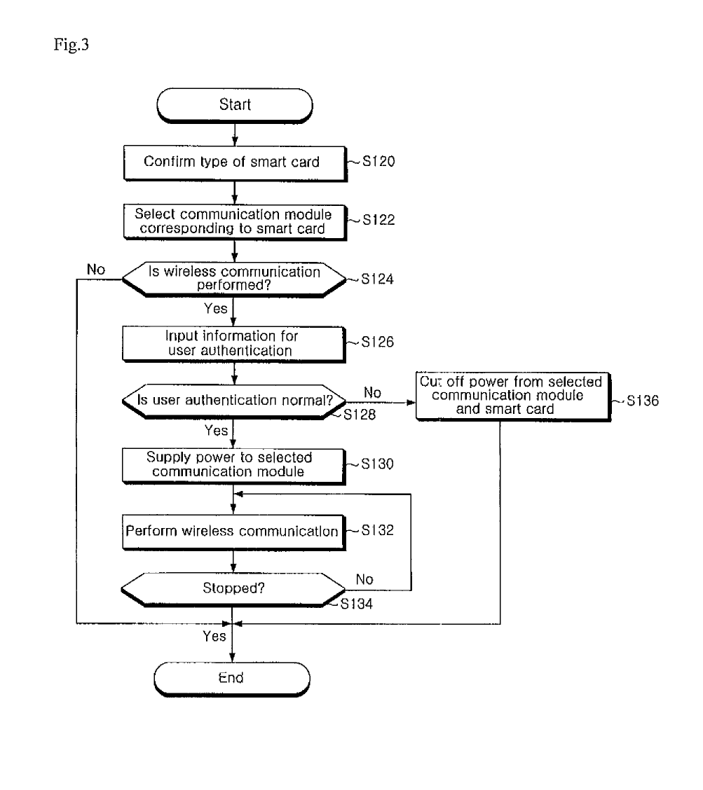

FIG. 3 is a flowchart illustrating a process of selecting a communication module corresponding to the smart card of which the type is confirmed in FIG. 2 and performing wireless data communication.

As shown in FIG. 2, if the communication type of the smart card 1 is determined (S120), the control unit 30 selects a communication module that supports the same communication type as that of the smart card 1 (S122).

That is, if the identification information is ‘00,’ the smart card 1 supports the WiBro type as described above, and thus, the WiBro module 12 that is the first communication module is selected. In addition, if the identification information is ‘B,’ the smart card 1 supports the HSDPA type, and thus, the HSDPA module 14 that is the second communication module is selected.

When a communication module is selected according to the identification information in this manner, the control unit 30 controls to perform wireless data communication using the communication module (S124). At this time, as a condition for performing the wireless communication, a user authentication process is preceded.

In the user authentication process, the control unit 30 requests to input user information (S126), and compares user information inputted by a user with the authentication information stored in the smart card 1. Then, the control unit 30 determines whether to supply power to the communication module according to a result of the comparison (S128).

Accordingly, if the authentication information is matched, the control unit 30 controls to supply power to the selected communication module and to perform wireless communication (S130 and S132). However, if the authentication information is not matched, the control unit 30 controls not to supply power to the selected communication module and further cuts off the power supplied to the smart card 1 (S136). As a result, if the user authentication is abnormal, wireless data communication cannot be performed through the mobile terminal apparatus.

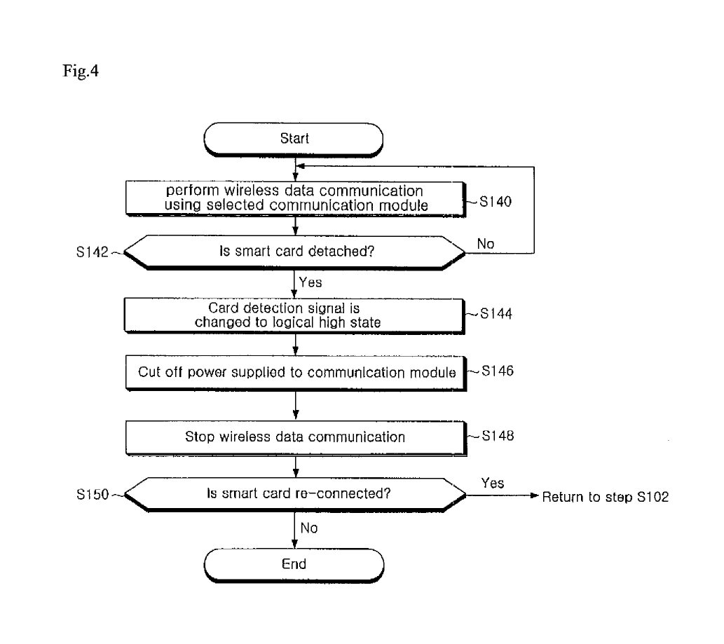

FIG. 4 is a flowchart illustrating a process of attaching and detaching a smart card according to an embodiment of the present invention.

First, the type of the smart card 1 is determined as shown in FIGS. 2 and 3. Then, a communication module is selected, and wireless data communication is performed in a desired communication method (S140). If the smart card 1 is detached on the way from the smart card interface unit 20 (S142), the control unit 30 does not receive a card detection signal from the smart card interface unit 20 (S144). That is, as describe above, the control unit 30 recognizes the smart card 1 as being attached to the smart card interface unit 20 only when the card detection signal is in a logical low state. If the smart card 1 is detached from the smart card interface unit 20 as described above, the card detection signal is in a logical high state, and thus, the control unit recognizes the smart card as being detached.

Then, the control unit 30 controls such that the power supply unit 40 cuts off the power supplied to the communication module that currently performs wireless Internet communication (S146). According to the power cutoff, the wireless data communication using the communication module is stopped (S148).

If the same or a different smart card 1 is connected again in step S150 while the wireless data communication is stopped, the process goes to step S102 and the control unit 30 determines the type of the smart card 1, selects a communication module corresponding thereto, and controls such that the power supply unit supplies power to the selected communication module, thereby performing wireless data communication.

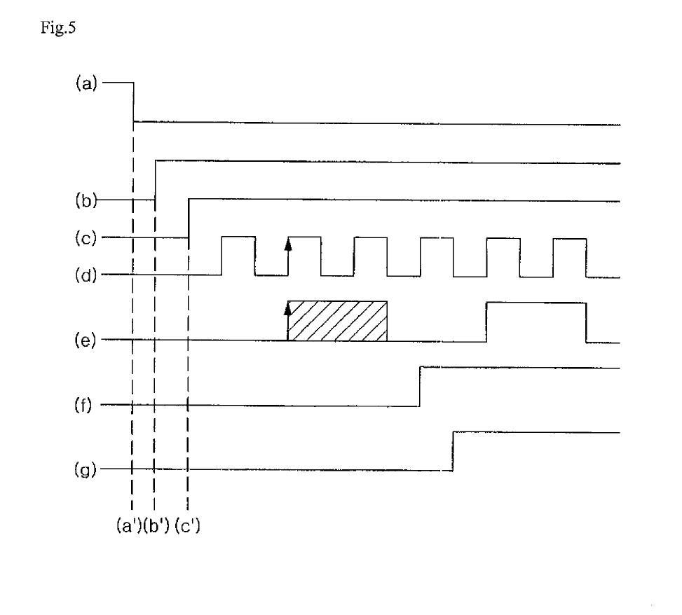

FIG. 5 is a timing chart showing the state of an electrical signal that is changed with the operations of attaching a smart card and selecting a communication module according to an embodiment of the present invention.

First, if the smart card 1 is not attached to the smart card interface unit 20, the card detection signal maintains a logical high state as shown in FIG. 5a. If the smart card 1 is attached, a card detection signal that is changed to a logical low state is generated from pin No. 8 of the smart card 1. Therefore, the control unit 30 recognizes that the smart card 1 is attached (time point a′).

Then, as shown in FIG. 5b, the control unit 30 controls the power supply unit 40 in a high active state (time point b′) to read packet data from the smart card 1. Then, as shown in FIG. 5c, the control unit 30 drives the power supply unit 40 (time point c′) to supply power to the smart card 1.

If the power is supplied, as shown in FIG. 5d, the control unit 30 provides a clock signal of a certain period to the smart card 1 and enables a read operation to read the packet data.

Then, the control unit 30 receives packet data stored in the storage unit 2 of the smart card 1. At this point, the control unit 30 first reads the identification information stored in the header of the packet data and determines the type of the smart card 1. That is, if power is supplied to the smart card 1, the packet data are transmitted from the smart card 1 according to a control operation of the control unit 30. Then, as shown in FIG. 5e, when the packet data start to be transmitted, the identification information contained in the first packet data is read by the control unit 30. A hatched area in FIG. 5e indicates that the identification information is contained.

Then, if the type of the smart card 1 is determined, the control unit 30 selects a corresponding communication module and supplies power to the communication module, thereby enabling wireless data communication.

Accordingly, if the communication module is selected, power is supplied to the communication module as shown in FIG. 5f, and the communication module is reset to an available state as shown in FIG. 5g.

For example, if the HSDPA module 14 of the high speed downlink packet access method is selected according to the type of the smart card 1, the control unit 30 controls to supply power to the HSDPA module 14, activates a ‘HSDPA_ON’ signal of the HSDPA module 14 to achieve a change thereof into an active high state, and further initializes the ‘HSDPA_RST#’ signal, thereby putting the HSDPA module 14 into an available state. At this time, a current state of the HSDPA module 14 is diagnosed. If an error or the like is detected, the function of outputting a corresponding error message is also selectively performed.

According to the present invention described above, it is understood that smart cards employing different communication methods can be processed using one smart card reader.

As described above, in the mobile terminal apparatus and the wireless communication method using the same according to the present invention, wireless Internet services can be used through the mobile terminal apparatus such as a notebook system.

In addition, various kinds of smart cards for use in a plurality of communication modules employing different communication methods can be processed using one smart card reader.

In a case where a conventional mobile terminal apparatus is provided with a plurality of communication modules and an authentication operation through a smart card is needed in using each of the communication modules, the convention mobile terminal apparatus is difficult to implement since a smart card reader corresponding to each of the communication modules should be added. However, according to the present invention, since a smart card reader is shared, a terminal apparatus of a small size can be designed and enables effective wireless communication using a variety of smart cards.

Although the present invention has been described in connection with the specific preferred embodiments, they are only for illustrative purposes. It will be readily understood by those skilled in the art that various modifications, changes and equivalents can be made thereto without departing from the spirit and scope of the present invention. Therefore, the true scope of the present invention should be defined by the technical sprit of the appended claims.

What is claimed is:

1. A mobile terminal apparatus comprising:
a wireless communication unit provided with at least two communication modules capable of performing wireless data communication;
a smart card interface unit for communicating with a smart card, the smart card containing user authentication information needed for the wireless data communication and identification information for use in selecting a communication module used for the wireless data communication; and
a control unit for confirming whether the smart card is provided and selecting and controlling one of the communication modules corresponding to the identification information received by the smart card interface unit.

2. The apparatus as claimed in claim 1, wherein the wireless communication unit comprises:
a first communication module including a first interface unit for communicating with the control unit; and
a second communication module including a second interface unit for communicating with the control unit, the second interface unit employing a communication method different from that of the first interface unit.

3. The apparatus as claimed in claim 2, wherein each of the communication modules communicates with the control unit using an identical type of interface unit.

4. The apparatus as claimed in claim 1, wherein the control unit controls to selectively supply power to the communication module corresponding to the identification information.

5. The apparatus as claimed in claim 1, wherein the control unit requests to input information needed for performing user authentication if any one of the communication modules is intended to be used.

6. The apparatus as claimed in claim 5, wherein the control unit compares the user authentication information stored in the smart card with the inputted user information, and controls whether to supply power to the communication module, based on a result of the comparison.

7. The apparatus as claimed in claim 2, wherein the communication modules comprise a WiBro module, a high speed downlink packet access module, and an EVDO module.

8. The apparatus as claimed in claim 1, wherein the identification information is first provided to the control unit when the smart card is recognized, and specific bits of the provided data are assigned to express the identification information in any one of a bitmap, binary digit, and vendor ID

9. The apparatus as claimed in claim 1, wherein after the smart card is mounted, the control unit controls to supply power to the smart card so as to read data stored in the smart card.

10. The apparatus as claimed in claim 9, wherein if the smart card is detached after being provided, the control unit controls to cut off the power supplied to the communication module.

11. The apparatus as claimed in claim 9, wherein if the smart card is provided, the control unit determines, based on a card detection signal generated from the smart card, that the smart card is connected to the smart card interface unit.

12. The apparatus as claimed in claim 11, wherein a logical low signal is generated as the card detection signal if the smart card is attached to the smart card interface unit, and a logical high signal is maintained as the card detection signal if the smart card is not attached to the smart card interface unit.

13. The apparatus as claimed in claim 1, wherein the smart card is a USIM card.

14. A wireless communication method using a mobile terminal apparatus, the method comprising the steps of:
detecting a smart card;
supplying power to the detected smart card;
if the power is supplied, reading identification information from the smart card and determining the type of the smart card; and
selecting, based on a result of the determination, a communication module corresponding to the smart card from at least two communication modules capable of performing wireless communication.

15. The method as claimed in claim 14, further comprising the step of supplying power to the selected communication module.

16. The method as claimed in claim 15, wherein the identification information is first read when the smart card is recognized.

17. The method as claimed in claim 15, further comprising the step of requesting to input information for user authentication if wireless communication is intended to be performed using the selected communication module.

18. The method as claimed in claim 17, wherein power is supplied to or cut off from the selected communication module based on a result of the user authentication.

19. A wireless communication method using a mobile terminal apparatus, the method comprising the steps of:
detecting a smart card attached to one smart card reader and supplying power to the smart card;
first reading identification information from the smart card;
preferentially determining a communication method employed in the smart card by referring to the identification information;
selecting a communication module corresponding to the smart card from two or more communication modules based on a result of the determination;
requesting to input information for user authentication if wireless communication is intended to be performed using the selected communication module; and
determining whether to supply power to the selected communication module, based on a result of the user authentication, and performing the wireless communication.

20. The method as claimed in any one of claims 19, wherein a plurality of interface units respectively provided in the communication modules to support certain communication methods perform communication through an identical type of interface.

21. The method as claimed in any one of claims 19, wherein a plurality of interface units respectively provided in the communication modules to support certain communication methods perform communication through an identical type of interface.

22. The method as claimed in any one of claims 19, wherein the communication modules perform wireless communication through different communication methods.

23. The method as claimed in any one of claims 19, wherein if a logical low signal is generated as a card detection signal from the smart card, it is determined that the smart card is connected to a smart card interface unit.

24. The method as claimed in any one of claims 19, wherein the identification information is expressed in as any one of a bitmap, binary digit, and vendor ID.

25. The method as claimed in claim 19, wherein if the smart card is detached, the power supplied to the communication module is cut off.
